(19) United States
(12) Patent Application Publication
(10) Pub. No.: US 2014/0369792 A1
(43) Pub. Date: Dec. 18, 2014

(54) DEVICE AND METHOD FOR COMBINING CARDS AND CARD SUPPORTS, FOR HANDLING CARDS AND/OR FOR SORTING CARDS

(71) Applicant: Boewe Systec GmbH, Augsburg (DE)

(72) Inventor: Heiner Kudrus, Eupen (BE)

(73) Assignee: BOEWE SYSTEC GMBH, Augsburg (DE)

(21) Appl. No.: 14/357,308

(22) PCT Filed: Oct. 4, 2012
(86) PCT No.: PCT/DE2012/000961

§ 371 Date: May 9, 2014

(30) Foreign Application Priority Data
Nov. 11, 2011 (DE) 10 2011 118 190.7
Mar. 13, 2012 (DE) 10 2012 004 830.0

(51) Int. Cl. B25J 9/00; B25J 9/16

(52) U.S. Cl. CPC B25J 9/0096; B25J 9/1679
USPC 414/222.02; 414/749.1; 414/222.13

(57) ABSTRACT

A device for combining cards and card supports in an application area, in which cards and card supports are united via an industrial manipulator, includes a card supplying element for supplying cards to the application area and a card support channel for supplying card supports to the application area, the device being designed as compact as possible. At least one card processing station, a measuring station and/or a reversible temporary storage area are arranged in the range of the manipulator.

The invention relates to an apparatus and a method for combining cards and card supports, for handling cards and/or for sorting cards.

Corresponding apparatuses are known, for example, from WO 2008/107839 A2, from WO 2004/039711 A1, from DE 10 2004 053 562 B4 and from U.S. Pat. No. 4,866,259, respectively. Thus, WO 2008/107839 A2 discloses an apparatus for combining cards and card supports in an application area, in which cards and card supports are united with one another by way of an industrial manipulator, with a card provisioning unit for supplying cards to the application area and with a card support channel for supplying card supports, which are generally present in the form of letters and the like, to the application area. In this connection, the cards in the card support channel are checked and electronically detected to the effect that a corresponding letter with the corresponding address is printed and can be supplied to the application area, in the card support channel, synchronously to the corresponding card. By means of a horizontal articulated arm robot as the manipulator, the cards are applied to the card supports in the application area, whereby the manipulator also sorts out defective cards to a separate stack; these must then be removed manually.

WO 2004/039711 A1 discloses a temporary storage unit or a card magazine, in which cards can be temporarily stored according to the FIFO principle.

U.S. Pat. No. 4,866,259 and DE 10 2004 053 562 B4, respectively, disclose apparatuses, in each instance, with which cards that are to be applied to card supports can be personalized. In this connection, these cards are provided not only with general data, such as a specific imprint of a company logo or the like, but also with personalized data, such as a personal photo of the user, the user name, or the like.

It is the task of the present invention to configure apparatuses of the stated type to be as compact as possible and to perform methods of the stated type on the most compact systems possible.

The task stated initially is accomplished by an apparatus for combining cards and card supports in an application area, in which cards and card supports are united with one another by way of an industrial manipulator, with a card provisioning unit for supplying cards to the application area, and with a card support channel for supplying card supports to the application area, which is characterized in that at least a card processing station and/or a measurement station and/or a reversible temporary storage unit is/are disposed within reach of the manipulator.

In deviation from WO 2008/107839 A2, which discloses a manipulator with two deposition positions, a unification position, and an ejection position for defective cards, and a card pickup position, this apparatus allows a particularly compact structure, because card processing stations, such as, for example, means for applying an adhesive location to the card, card printers, embossers—in other words apparatuses with which embossings of the card can be undertaken—, means for writing to the magnetic strip and/or means for writing to an electronic memory on a card, can be disposed in the immediate vicinity of the manipulator, thereby making it possible to select the entire construction length or construction size of the corresponding apparatus to be smaller, accordingly. The same holds true for the possibility of disposing a measurement station for recording specific card properties, such as, for example, a camera, particularly with suitable image recognition, a magnetic strip releaser, a chip reader, or the like, in the immediate vicinity of the manipulator, which accordingly also allows the entire apparatus to have a significantly more compact construction.

The reversible temporary storage unit, in particular, is advantageous, in contrast to the ejection location for defective cards that is disclosed in WO 2008/107839 A2, because possible cards that are incorrectly fed in by way of the card provisioning unit due to sorting errors or other prior errors can be temporarily stored there, so that the actual application process can continue to be pursued without disruption. At the appropriate time, cards can be picked up by the manipulator again, by way of the temporary storage unit, if suitable card supports are available. In particular, this is advantageous in connection with card processing stations by way of which possible errors are corrected, such as, for example, corresponding electronic writing apparatuses for chips or other memory cards. Particularly if the card processing station serves to apply an adhesive location, for example, this arrangement makes it possible to temporarily store the card without an adhesive location, so that the latter is not corrupted over time, and to apply the glue dot only just before application.

Accordingly, the task stated initially is also accomplished by a method for combining cards and card supports in an application area, in which cards and card supports are united with one another by way of an industrial manipulator, wherein the method is characterized in that the manipulator, after picking up the card and before uniting it with the card support, passes the card to a card processing station and/or a measurement station and/or a reversible temporary storage unit, as needed.

In this connection, it is particularly advantageous, because it can also be implemented very easily, if the manipulator puts a card into the reversible temporary storage unit and takes it out again from the reversible temporary storage unit, if needed.

Under some circumstances, it is necessary to remove cards that have been placed into the temporary storage unit from the process completely, for example because an adhesive location that has already been placed onto the corresponding card has become corrupted because it was stored in the temporary storage unit too long. Such removal can take place manually, for example, if the entire apparatus is at a stop—manual removal during operation is generally excluded, for safety reasons alone, in view of the manipulator and the hazards that proceed from it. On the other hand, a card removal transport can be provided in the area of the manipulator, particularly as a temporary storage unit or temporary storage location, which transports cards out of the area of the manipulator, so that the cards, which must then ultimately be sorted out or reworked or newly processed in some other way, become accessible even during process operation. Such a card removal transport can be, for example, a separate conveyor, such as, for example, a transport belt, or also simply a card slide or the like. In this connection, groups of cards can also be sorted out together, for example, in that a carriage that collects cards is used accordingly.

Depending on the concrete method management, it can be advantageous, accordingly, to use the manipulator also to sort out card supports, for whatever reason, for example if they are defective. This can be done, for example, in that the manipulator manipulates a card support accordingly, using an effector disposed on it, whereby, for example, it merely simply sweeps over a corresponding surface and pushes a card support aside. Likewise, the effector that is provided for the cards, such as a suction device, for example, can be used for the purpose of grasping a card support and putting it down at a different location for being sorted out.

The advantages of a manipulator can particularly be optimally used when at least two temporary storage locations are disposed within reach of the manipulator. In particular, it is also possible to provide at least three temporary storage locations that are disposed in two dimensions relative to one another. Depending on the concrete embodiment of the manipulator, a three-dimensional arrangement of temporary storage locations for cards can actually be provided, if correspondingly many temporary storage locations are supposed to be available in compact manner. Such an embodiment of the apparatus, in which the manipulator itself can reach multiple temporary storage locations and put down or pick up cards there, can be implemented very easily, in terms of design, and allows temporary storage of cards in very individual manner and in a compact space, and returning them to the corresponding process, in very flexible manner, without additional measures.

In connection with the above description, it should be emphasized that debit cards, credit cards or similar cards can particularly be used as cards. Likewise, SIM cards or chips, particularly telephone chips, can accordingly be united, as cards, with card supports. In this regard, the term “card” in the present connection comprises planar, essentially inherently rigid bodies, which are not larger than 10 by 10 cm.

The card provisioning unit particularly comprises the card channel known from WO 2008/107839 A2, but also corresponding magazines as they are disclosed there. In view of the use of a manipulator and its varied use possibilities, however, the card provisioning unit can also comprise a table or a chute, if it is suitably ensured that the manipulator can recognize a card as such and pick it up in operationally reliable manner. In this way, in particular, a complicated sorting process can be avoided right from the start, and individual cards, for example, can be very easily supplied to a corresponding apparatus, in that they are merely laid down onto a corresponding table. Likewise, it is possible that the manipulator takes cards directly out of a magazine. Also, arrangements that serve for temporary storage, such as stacked compartments or specific drop locations of a card provisioning unit, for example, can serve.

In practical experiments, such a reversible temporary storage unit has proven to be extremely advantageous, and this relates not only to feed errors of card supports that occur very rarely, but can occur as part of the process, but also to card support defects as such. Particularly, however, in the case of small series, the sorting processes of which might not be carried out automatically, a corresponding reversible temporary storage unit proves to be extremely advantageous. These advantages can particularly be utilized if the temporary storage unit has addressable temporary storage locations, because then not only random but also targeted removal of cards situated in the temporary storage unit is possible. In this regard, it is possible that a card support is requested and made available by way of the card support channel for a card situated in the temporary storage unit, for example, thereby making it possible for incorrectly assigned cards, for example, or cards that were placed in the temporary storage unit because a related card support that was to be united with this card had to be sorted out during an interim inspection, because it was defective, can be transferred back into the overall process in rapid and operationally reliable manner.

Accordingly, the task stated initially is also solved by an apparatus for combining cards and card supports in an application area in which cards and card supports are united with one another, with a card provisioning unit for supplying cards to the application area, with a card support channel for supplying card supports to the application area, and with a temporary storage unit for temporarily storing at least two cards, wherein the apparatus is characterized in that the temporary storage unit has temporary storage locations that can be individually addressed. Particularly in deviation from WO 2004/039711 A1, which does not make such targeted removal possible, free access to the cards that are stored in the temporary storage unit is therefore possible, so that it is possible to react to possible disruptions in rapid and individual manner. It is understood that such an apparatus with addressable temporary storage locations is advantageous even independent of the use of a manipulator, whereby—as has already been indicated above—the corresponding advantages can particularly be synergistically utilized in interplay with a manipulator.

On the other hand, such a card magazine with independently addressable card locations, utilized as a temporary storage unit, also proves to be advantageous independent of the other characteristics of the present invention. Accordingly, the task stated initially is also accomplished by a magazine for cards having at least one input and/or output and having a card storage unit having a plurality of card locations, the card locations of which are displaceable relative to the input and/or output, by means of a drive, which magazine is characterized in that an absolute or relative address is assigned to each of the card locations, and an actuator controls the drive until an addressed card location is disposed at the input and/or output. In this connection, it is understood—depending on the concrete implementation of the present invention—that the card locations are moved and the input and/or output remain(s) fixed in place, as disclosed in WO 2004/039711 A1, which brings about the advantage that flexible transport to the input and/or output is not necessary. On the other hand, it is possible to move the input and/or output, while the card locations remain fixed in place, which then requires corresponding flexible transport to and from the movable input and/or output. Likewise, it is possible that not only the input and/or output but also the card locations are moved, as long as there is a relative movement of the input and/or output with regard to the card locations. In this connection, it should also be emphasized that a magazine generally provides for essentially one-dimensional placement of the card locations, which are disposed linearly or one behind the other in the case of a stacked magazine, and on a closed track in the case of a circular magazine.

The actuator of the drive preferably has a signal input for indicating a card location address, so that a corresponding card location can be requested in simple and precise manner at the input and/or output, for input of a card into the card magazine or into the corresponding temporary storage unit or for output or removal of a card from the card magazine or from the corresponding temporary storage unit.

Precise and rapid provisioning of a desired card location takes place if the actuator has a signal output for indicating if a specific card location is disposed at the input and/or output. The latter can be, for example, the precise address, an identification of a card situated in the magazine at this address, or simply a binary signal, the latter when the desired card location address has been reached. Preferably, the indication at the signal output only occurs if the card location is also accessible by way of the input and/or output, so that in this manner, incorrect access can be restricted to a minimum, without any further measures.

Absolute addressing of the card locations can also be implemented in particularly simple manner if an address support that bears a clear address is assigned to each card location, and an address reader is provided in a spatially fixed relation to the drive, with the address supports moving past the drive as the card locations are moved.

If the drive comprises a reversal of direction, the access time can be restricted to a minimum, particularly in the case of circular magazines or card locations disposed in endless manner relative to one another. Furthermore, a reversal of direction also allows flexible use of the card magazine, while card locations disposed in endless manner relative to one another allow a great number of card locations in the card storage unit, also independent of this, in space-saving manner.

In order to allow cards already provided with adhesive, which are subsequently supposed to be applied to a card support by means of the adhesive, to be stored in the card magazine or in a corresponding temporary storage unit, without the adhesive degenerating too much, each card location can have at least one card holder assigned to it, which has a recess and a holder edge that surrounds the recess at least on two sides, which edge comprises a card contact surface, so that adhesive can be present on the card in the area of the recess. It is understood that this characteristic is correspondingly advantageous even independent of the other characteristics of the present invention, in the case of a card magazine or a temporary storage unit.

Accordingly, the task stated initially is also accomplished by a method for combining cards and card supports in an application area, in which cards and card supports are united with one another in targeted manner, wherein any non-matching cards or cards to be handled separately are temporarily stored in a temporary storage unit, wherein the method is characterized in that the cards are removed from the temporary storage unit in targeted manner and united with a related card support.

In this connection, it is easily possible, in particular, that before targeted removal of a card from the temporary storage unit, a card support that corresponds to this card is made available in the application area, wherein this can easily also take place, if applicable, together with or after targeted removal of the card, insofar as a card situated in the temporary storage unit is selected, by way of corresponding programming, as a card to be applied at a specific point in time. The actual removal can then take place at a point in time when the card support and the card that are to be united with one another get into the application area in correspondingly synchronized manner.

In this regard, it is advantageous if each card support has a card support data set assigned to it and each card has a card data set assigned to it, and two card supports and cards to be united are first identified, and targeted removal from the temporary storage unit takes place when the identified card support is being supplied to the application area. In this manner, the method can be carried out in extremely effective manner.

As has already been explained above, the temporary storage unit can have temporary storage locations that can be reached directly and individually by the manipulator, so that targeted removal from these temporary storage locations is possible. Alternatively, it is also possible to deposit cards in stacked manner on corresponding temporary storage units, so that addressed and targeted removal is no longer possible, because ultimately, such stacks can be used according to the FILO principle. Instead of corresponding stacks, however, magazines can easily be used, whereby these can be stacked magazines, for example, which also work according to the FILO principle. Likewise, however, magazines such as those disclosed in WO 2004/039711 A1, for example, can also be used, in this regard, whereby preferably, an input and/or output of the magazines, in each instance, whether they are stacked magazines or circular magazines or some other magazines, are disposed in the area of the manipulator. Depending on the concrete implementation of the present invention, these magazines can have addressable storage locations, so that here, too, targeted removal is possible, something that is not possible in the case of magazines with non-addressable storage locations as such, without individual card recognition.

Accordingly, it is also advantageous if the removal from the temporary storage unit takes place by means of a manipulator, wherein this manipulator, depending on the concrete implementation of the present invention, either directly moves to a temporary storage location or picks up a card from an input and/or output of a temporary storage unit or sets it down.

In this regard, it is also advantageous, with regard to method management, if the manipulator sets down cards at different temporary storage locations and picks them up again there, if needed, and/or if the temporary storage unit comprises a magazine with an output, from which the manipulator can pick up a card, as needed, after it the magazine makes the corresponding card available at the output. All of this leads to extremely flexible method management, with a compact structure of the corresponding system.

As was already provided initially, it is advantageous if at least one card processing station is disposed within reach of the manipulator, particularly because this allows a correspondingly compact structure of the apparatus. During the course of the investigation of a corresponding system, it turned out that the advantages of the combination of a manipulator with at least one card processing station, particularly also in the case of multiple card processing stations, are so serious, independent of whether cards are combined with card supports by way of a corresponding apparatus, that compact processing of cards is already possible in the case of an apparatus for handling of cards, with a card provisioning unit and a card output unit, as well as a manipulator, within reach of which both the card provisioning unit and the card output unit are disposed, as is disclosed as an example in WO 2008/107839 A2, by means of a card processing station within reach of the manipulator, even independent of application to a card support. In particular, for example also in the case of apparatuses for personalization, as they are disclosed in U.S. Pat. No. 4,866,259 or DE 10 2004 053 562 B4, an extremely compact arrangement can be made possible, because ultimately, card output unit, card provisioning unit, and processing station can be disposed very closely together around the manipulator, in each instance. In particular, further processing stations can accordingly be disposed close to the other components of this apparatus.

Frequently, cards also have to be sorted. This happens, for example, in a separate work step and on a separate machine, before application to a card support, in which step cards of different types, for example, such as a personalized debit card and a non-personalized gift certificate card, for example, are alternately placed, in each instance, into a magazine, which is then passed to an application apparatus, so that the cards can be successively removed from this magazine and supplied to the application area. In this connection, it is not necessarily only the sequence of the cards that must be sorted, but rather possibly also the position of the card—in other words the front or back upward or a specific orientation in the card plane—that must be influenced in targeted manner. Corresponding sorting processes can also be necessary if accidents occur and a filled magazine falls down, for example, and is suddenly emptied. Even if multiple magazines are present at an application apparatus, sorting processes might become necessary, if, for example, gift certificate cards having different values are made available in one magazine, and personalized cards are made available in another magazine, whereby the personalized cards might also have to be sorted if they are supposed to be applied to letters that are to be sent to different countries or are sorted by postal code, for example.

A corresponding sorting apparatus for sorting cards, with a card provisioning unit and a card output unit, has a relatively compact construction if it comprises a temporary storage unit and an industrial manipulator, which takes cards from the card provisioning unit and puts then down at the card output unit, if necessary with use of the temporary storage unit.

In particular, also in the case of such an arrangement, however, also in the case of the aforementioned arrangements, the temporary storage unit can be utilized as a card provisioning unit. In this regard, the cards to be sorted or to be processed or handled some other way can also be applied to the temporary storage unit manually or some other way, and can be passed into the apparatus or into the process from there, for sorting or other processing or handling.

As was already explained initially, a table or the like can particularly also serve as a card provisioning unit, so that the card can be supplied to the corresponding sorting device in very simple and unsorted manner, particularly if this apparatus can sort, in a concrete embodiment, not only with regard to sequence but also with regard to orientation, whereby accordingly preferred embodiments that are helpful in this regard will be explained below.

The task stated initially is also accomplished by a method for sorting cards, which is characterized in that the cards are removed from a card provisioning unit by means of an industrial manipulator and output at a card output unit, in sorted manner, wherein the cards are possibly temporarily stored for sorting.

In particular, it is also possible to output the cards to different output locations at the card output unit, for example to assign them to different magazines.

Accordingly, it is also advantageous if the card output unit comprises multiple output locations. Multiple output locations or a card output unit at different output locations particularly allows sorting by different card types, such as, for example, according to the presence of a magnetic strip and/or a chip, or kinds of cards, such as, for example whether they are debit cards or credit cards, chips, SIM cards or telephone chips, electronic memory cards or the like.

It is similarly advantageous for sorting apparatuses, as in the case of the apparatus mentioned above for combining cards and card supports, if a measurement station or a card processing station is provided, so that on the one hand, automatic recognition of the card or its orientation and, on the other hand, processing, such as personalization, in particular, is possible, if applicable. It is true that a temporary storage unit within reach of the industrial manipulator already brings about very good sorting capacity and a compact construction. If one or more measurement stations or one or more card processing stations are situated within reach of the manipulator, especially many corresponding measures can be performed in a spatially very limited, therefore compact area, in compact manner.

In particular, it is possible, by way of measurement stations, to also administer a database accordingly, so that the sorted cards are also correspondingly recorded in a database. In this connection, the configuration of a magazine into which cards are sorted can particularly be recorded in the database, independent of whether data sets belonging to the cards, in each instance, are already assigned to the cards, or whether this must still be done, by way of corresponding measurement stations.

The advantages of a manipulator on a sorting apparatus or in connection with a sorting method can particularly be optimally utilized if at least two temporary storage locations or at least three temporary storage locations, which locations are disposed in two dimensions relative to one another, are disposed within reach of the manipulator. Depending on the concrete embodiment of the manipulator, a three-dimensional arrangement of temporary storage locations for cards can actually be provided, if correspondingly many temporary storage locations are supposed to be available, in compact manner. Such an embodiment of the apparatus, in which the manipulator itself can reach multiple temporary storage locations and can put down or pick up cards there, can be implemented very easily, in terms of design, and makes it possible, without further measures, to store cards temporarily very individually and in a compact space, and to return them to the corresponding process in very flexible manner.

In practical experiments, a reversible temporary storage unit has also proven to be extremely advantageous in sorting apparatuses and sorting methods. Particularly in connection with small series, sorting procedures can be conducted automatically in this manner. These advantages can particularly be utilized if the temporary storage unit has addressable temporary storage locations, because then, not only random but rather targeted removal of cards situated in the temporary storage unit is possible.

Accordingly, the use of an independently addressable temporary storage location, in particular, is also advantageous, by means of which each individual card and each storage location of the temporary storage unit is very flexibly available for sorting procedures, particularly for a corresponding manipulator.

In this regard, also in the case of sorting procedures, cards can be advantageously removed from the temporary storage unit and output, in sorted manner, at a suitable location.

As was already explained above, the temporary storage unit can have temporary storage locations that can be reached directly and individually by the manipulator, so that targeted removal from these temporary storage locations is possible. Alternatively, it is also possible to put cards down, stacked, onto corresponding temporary storage units, so that addressed and targeted removal is no longer possible, because ultimately, such stacks can be utilized according to the FILO principle. Instead of corresponding stacks, however, magazines can easily be used, whereby these can be stacked magazines, for example, which also work according to the FILO principle. Likewise, however, magazines such as those disclosed in WO 2004/039711 A1, for example, can also be used, whereby preferably, an input and/or an output of the magazines, whether they are stacked magazines or circular magazines or another type of magazines, is/are disposed in the area of the manipulator, in each instance. Depending on the concrete implementation of the present sorting method and sorting apparatuses, these magazines can have independently addressable storage locations, so that here, too, targeted removal is possible, which is not possible in the case of magazines with non-addressable storage locations as such, without individual card recognition.

Accordingly, it is also advantageous if the removal from the temporary storage unit takes place by means of a manipulator of the sorting apparatus, whereby this manipulator, depending on the concrete implementation of the present invention, either moves to a temporary storage location directly, or picks a card up from or sets a card down at an input and/or output of a temporary storage unit.

In this regard, is it also advantageous, with regard to method management, if the manipulator sets down cards at different temporary storage locations and picks them up again there, as needed, and/or if the temporary storage unit comprises a magazine with an output, from which the manipulator can pick up a card, as needed, after it the magazine makes the corresponding card available at the output. All of this leads to extremely flexible method management, with a compact structure of the corresponding system.

In this regard, it should be emphasized that the explanations above and below with regard to apparatuses and methods with regard to the application of cards to card supports or with regard to handling of cards, particularly with reference to the different embodiments of the temporary storage units, can particularly be advantageously utilized also for methods and apparatuses for sorting of cards.

In connection with an extremely compact embodiment of the corresponding arrangements, it should be emphasized that if necessary, a measurement station, particularly, for example, a camera, or also card processing station, such as, for example, a punch or a device for application of an adhesive location, can also be disposed directly on the manipulator or on its effector, whether it is merely a component of the handling apparatus or also of an application apparatus or sorting apparatus.

As was already indicated above, it can be advantageous if the manipulator turns the card, as needed. Accordingly, a method for combining cards and card supports and/or for sorting and/or handling of cards is also advantageous, in which the cards are brought from a card provisioning unit to a card output unit by means of a manipulator, if the manipulator turns the card, as needed. In this way, suitable sorting of the cards can be undertaken in compact manner.

Preferably, the card will be recorded by a camera before being turned, so that its orientation can be determined. This can be dome, for example, by means of suitable image recognition or by means of a comparison with card-specific data stored in a database. Likewise, it is possible that cumulatively or alternatively to this, the orientation is determined by way of the position of a magnetic strip or other component, which can be detected by means of other measurement stations. For example, the position of the magnetic strip can possibly be determined by means of multiple trial procedures, by way of a magnetic strip reader.

For structural implementation of this method of procedure, it is accordingly advantageous if an apparatus for handling or sorting cards and, if applicable, also an apparatus for combining cards and card supports, with a manipulator, has at least one module of a turner for turning the cards. In this connection, it is accordingly particularly advantageous, of course, if the entire turner is provided on the manipulator, but this—depending on the concrete embodiment of the manipulator or its effector—might be very complicated. In this regard, it is possible, for example, that the manipulator merely has a correspondingly rotatable gripper or card holder, which does not, however, have its own motor drive, so that the manipulator performs a corresponding rotational movement for turning the card by being moved past a projection, for example. In the case of such an embodiment, the turner comprises the corresponding rotatable card holder, on the one hand, and the corresponding projection, on the other hand, which itself is not disposed on the manipulator, as a module.

For clarification or definition, it should be emphasized at this point that the terms “turner” and “turning” relate to a rotation of the card, during which the axis of rotation lies in the card plane or parallel to it. By means of turning, a top or bottom of a card can thereby be exchanged. This should be distinguished from rotation, in which a related axis of rotation is oriented perpendicular to the card plane, so that the card rotates in its card plane. In this way, a magnetic strip can be brought into the correct position, for example, or the orientation of a card on a card support can be influenced in suitable manner, whereby such rotation is possible also in the case of the arrangement according to WO 2008/107839 A2, for example, by means of the manipulator disclosed there.

Accordingly, it is also advantageous if the manipulator comprises a rotator module.

By means of turning and/or rotation, the orientation of a card, in particular, can be changed not just during application but also independent of this, in interplay with processing or measurement stations, so that both sides of a card can be recorded by a camera, for example. Likewise, a magnetic strip reader can read both sides of a card, or can also attempt a reading procedure at different positions of a card. The same holds true, of course, for other processing and measurement stations.

As was already explained above, it is particularly advantageous if a turner and/or a rotator is/are disposed on an effector of the manipulator. This allows a particularly compact structure of the overall arrangement, and, in particular, also compact method management, because turning and/or rotation can be performed during the movement of the manipulator. Preferably, two card carrying tools with different effects are disposed on an effector of the manipulator. This allows particularly great flexibility in handling of the card by means of the effector, particularly also while the manipulator is in motion.

Thus, for example, a first card carrying tool can be particularly designed to pick cards up from a deposition area or from a stack, which can particularly be implemented by means of a suction device, for example. By means of such a suction device, application onto a card support is also possible in very simple manner. It is true that it is also possible to use a gripper for this purpose, which grasps the card from above, with “pointed fingers,” so to speak. However, because the cards are relatively thin, of course, such grasping is generally relatively prone to errors, particularly if great accelerations are caused by the manipulator. Instead of a suction device, it is understood that other suitable holding or carrying tools can also be used, such as, for example, electronically acting adhesion devices or the like, which enter into interaction with a card by way of one of its flat sides, in each instance.

A disadvantage of such suction devices or other card carrying tools, which essentially act on the card from one side, is that turning is only possible with difficulty and, in particular, only with a relatively large construction space. With reference to the card carrying tool, in each instance, turning is actually precluded, as long as this tool is holding the card. The situation is different for grippers or similar card carrying tools that interact with a card by carrying it from the side. Such tools can easily perform a turning procedure, but it is extremely difficult to apply a card onto a card support by means of such tools or to set it down in targeted manner. For this purpose, further measures are generally required, if it is possible at all. On the other hand, such a card carrying tool, particularly if it grasps the card from the two surface sides, carries a card in relatively operationally secure manner, but this might have the disadvantage that specific areas of the card are not accessible to processing or measurement, because they might be covered by the gripper or by the modules of the corresponding card carrying tool.

In view of these advantages and disadvantages, it is advantageous if the second of the two card carrying tools on the effector is a gripper or a similar carrying device that acts on the card from two opposite sides.

A horizontal articulated arm robot, as presented in WO 2008/107839 A2, for example, as an example, is particularly suitable as a manipulator. Such an articulated arm robot is extremely flexible, on the one hand, and, on the other hand, is sufficiently stable even at great movement speeds or accelerations. On the other hand, robots or manipulators with serial kinematics, in other words, for example, articulated arm manipulators or portal manipulators, or with parallel kinematics, in other words, for example, hexapod robots or delta robots, are possible manipulators, whereby—as already explained above—horizontal articulated arm robots or SCARA ([in English:] Selective Complains Assembly Robot Arm) robots can preferably be used, because these are available in cost-advantageous manner, on the one hand, and, on the other hand, have a relatively stable construction even at high speeds.

As was already indicated above, it is advantageous if the manipulator carries a camera and/or another measurement station on an arm, preferably on its effector. This can be a barcode reader, for example, whereby a camera with suitable image recognition can also be used as a barcode reader. Also, a magnetic strip reader or an RFID reader or another kind of chip reader, for example, can be provided on the manipulator. The latter, in particular, is advantageous, because reading of electronic memories on a card is often relatively time-consuming, so that a relatively long time is available for reading while the manipulator holds a card and moves to possible processing stations, such as an apparatus for applying an adhesive location, for example, or another magnetic strip reader supplementally provided elsewhere. Likewise, it is possible to provide a processing station, such as, for example, a chip card writing device or the like, on the manipulator or on the effector.

If the card processing station, whether it is disposed within reach of the manipulator with at least one module on the manipulator or its effector, or elsewhere in the corresponding apparatus, comprises a card printer such as an inkjet printer or film printer, particularly for imprinting pictures, a card embosser, means for writing to a magnetic strip and/or means for writing to an electronic memory on a card, then personalization of the corresponding card can be implemented in particularly compact manner, and this is significantly advantageous for small series or for special productions, for example if a personalized card was lost. In particular, such embodiments of the apparatuses or methods indicated above are suitable for incorporating correspondingly individualized or personalized cards, which are needed individually or in small series, into large-series production, without having to make overly great effort and, in particular, without making too much space available for additional assemblies, which might only be needed rarely.

The card processing station can, in particular, also comprise a means for applying an adhesive location on a card, which can be implemented by means of applying a corresponding glue dot or also by spraying on an adhesive or by pasting on a double-sided adhesive label, for example. Such application means can also be provided on the manipulator or its effector, if applicable, whereby, since a regular refill requirement generally applies, an arrangement in the vicinity of the manipulator or within its reach is advantageous, so that the corresponding adhesive location can be applied to the card just shortly before its application to a card support.

If a database contains not only card-specific data, sorted by card type and kind of card, which ultimately is already known from the state of the art, but also visual data and/or position data about modules of the card of at least one card type and/or one kind of card, then a card can be oriented in accordance with the desired default values, and output at a card output unit, if necessary in sorted manner, or applied to a card support, in rapid and operationally reliable manner, in distinction from the state of the art for apparatuses for combining cards and card supports and/or apparatuses for sorting and/or handling or cards, independent of the other characteristics of the present invention. This is particularly advantageous if cards are passed to the corresponding apparatus completely unsorted, for example lying on a table. In particular, however, correcting intervention can occur also in the case of incorrect orientations, which, although they occur extremely rarely, cannot be entirely precluded, even during a large order, so that the actual process that is working on the large order is not influenced or impaired, or only to an insignificant extent.

Preferably, the corresponding apparatuses comprise measurement stations by means of which data complementary to the visual data and/or position data about modules contained in the database can be measured on a corresponding card. In particular, these can be corresponding cameras that record such visual data. Likewise, scanners can also be used in this regard. Scanning devices or reading devices that respond when a corresponding module is situated in a position complementary to the reading device, for example, can be used for determining the position data of modules.

The task stated initially is also accomplished by an apparatus for combining cards and card supports and/or for sorting and/or handling cards, with a database that contains card-specific data sorted by card types and kinds of cards, which apparatus is characterized in that it has a reversible temporary storage unit with at least one temporary storage location, and that the database contains card-specific data about a card temporarily stored in the temporary storage unit. By means of such an apparatus, subsequent assignment of a card situated in the temporary storage unit to a card support can take place in compact manner, whereby—depending on the concrete implementation of this solution—a corresponding card support can be requested before, while or after the card is placed in the temporary storage unit. In this connection, it is particularly possible that a corresponding process controller removes a corresponding card from the temporary storage unit again, in targeted manner, on its own, and unites it with the related card support when the latter is accordingly made available. On the other hand, it is also possible that the card support channel has measurement stations that detect a specific card support as such, whereupon a corresponding card is then removed from the temporary storage unit in targeted manner, and united with corresponding card supports.

Preferably, the reversible temporary storage unit is addressable, which significantly facilitates the method management explained above, independent of whether only handling or, in contrast, sorting or application is involved, whereby this is even further facilitated if the temporary storage unit is independently addressable, so that targeted removal from the temporary storage unit can take place at any time and very rapidly.

Depending on the concrete requirements, an order for making a matching card support available can be issued before, while or after a related card has been placed in the temporary storage unit. This ultimately depends on when during the method sequence it can be determined that a card support matching a card is not available, for example if this support had to be sorted out subsequently, during an inspection, before uniting takes place.

In particular, the card support can be prepared in accordance with default values from a database, taking the card-specific data in the database into account, in each instance. Thus, for example, in the case of a personalized card, a correspondingly personalized letter can be produced, which is then united with the related card as a card support, which card, in turn, is temporarily stored in the temporary storage unit until the related card support has been prepared.

In a preferred embodiment of the method, a card can be removed from the temporary storage unit in targeted manner when a related card support is being supplied to the application area. Preferably, for this purpose, individual data of the card support are measured, for example by means of optical image detection and recognition of an address field or by means of reading a barcode, and the temporary storage location of the card, in each instance, is determined on the basis of the measurement values, from a database. Such method management is extremely flexible, because ultimately, corresponding card supports can also be introduced into the card support channel by hand. Because, on the one hand, the individual data of a card support situated at a specific location of the card support channel are known, if necessary by means of corresponding measurement or detection, alternatively, of course, targeted addressing of the corresponding temporary storage location can take place on the basis of these data.

Independent of the other characteristics of the present invention, the task stated initially is also accomplished by a method for handling cards with a manipulator, the effector of which has a first card carrying tool, whereby the method is characterized in that a card picked up by the first card carrying tool of the manipulator is handed over to a second card carrying tool, subsequently the card is manipulated, in other words processed, checked, turned, rotated, —particularly in the case of faster movement sequences—securely held or set down, and afterwards transferred back to the first card carrying tool of the manipulator. As was already explained above, specific card carrying tools, particularly, for example, suction devices or other card carrying tools that engage only on one surface of a card, are particularly suitable for certain activities, such as, for example, lifting cards from flat surfaces or stacks and setting them down onto flat surfaces or stacks, which such card carrying tools are ultimately unsuitable for other activities, particularly for a turning procedure or also processing on both sides. On the other hand, card carrying tools that can particularly be used as second card carrying tools and that grasp a card from two sides, either from its front and back or from two opposite edges, generally hold a card in significantly more operationally reliable manner, whereby then, setting it down or picking it up is relatively difficult without further supplemental measures.

This handicap can be countered by means of the use of different card carrying tools, whereby the second card carrying tool does not necessarily have to be disposed on the manipulator or an effector of the manipulator, as well. Instead, a card turner, for example, can also be disposed within reach of the manipulator, so that a card can be transferred to the card turner, turned, and subsequently taken over by the second card carrying tool again, whereby in the case of such an embodiment, the turner has the second card carrying tool that carries the card during turning.

Preferably, the second card carrying tool is also provided on the effector of the manipulator, so that a card held by the first card carrying tool of the manipulator can be transferred to a second card carrying tool of the effector, which accordingly accomplishes the task stated initially, even independent of the other characteristics of the present invention, in the case of a method for handling cards with a manipulator, the effector of which has a first card carrying tool.

As was already explained above, the first card carrying tool can particularly be a card carrying tool that can grasp and carry a card from only one card surface, while the second card carrying tool is preferably a card carrying tool that grasps a card from two sides or from two edges. Depending on the concrete embodiment, particularly if the card are accessible for a gripper from its two sides, the first card carrying tool can also be a gripper, while the second card carrying tool does not need to be disposed on the manipulator and nevertheless is a suction device, for example, or another card carrying tool that acts on only one surface, which tool is disposed, for example, directly above the card supports that pass through the application area, and can apply a card by lowering it, while the gripper previously transfers the corresponding card to this second card carrying tool from below.

It is understood that the characteristics of the solutions described above and in the claims, respectively, can also be combined in order to be able to implement the advantages cumulatively, accordingly. In particular, it should be emphasized that the solutions described above or in the claims in the case of a handling apparatus or in the case of a handling method, can be used also in the case of corresponding sorting and application apparatuses and methods. Likewise, the solutions described above or in the claims in the case of sorting apparatuses and methods can also be used, to corresponding advantage, in the case of application apparatuses and methods.

Further advantages, goals, and properties of the present invention will be explained using the following description of exemplary embodiments, which are particularly also shown in the attached drawing. The drawing shows:

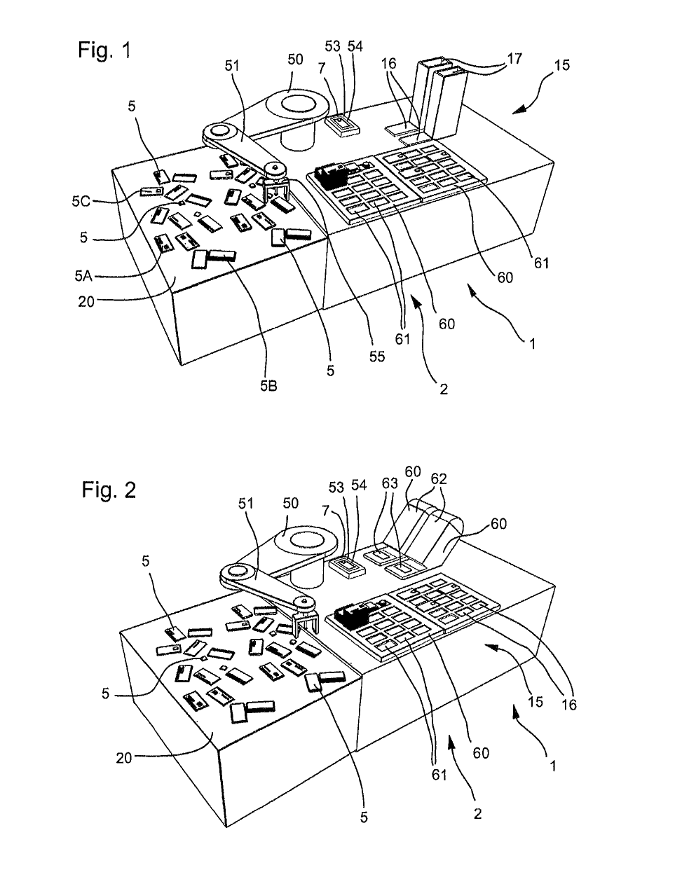

FIG. 1 a first sorting apparatus with a manipulator in a perspective schematic view;

FIG. 2 a second sorting apparatus with a manipulator in a perspective schematic view;

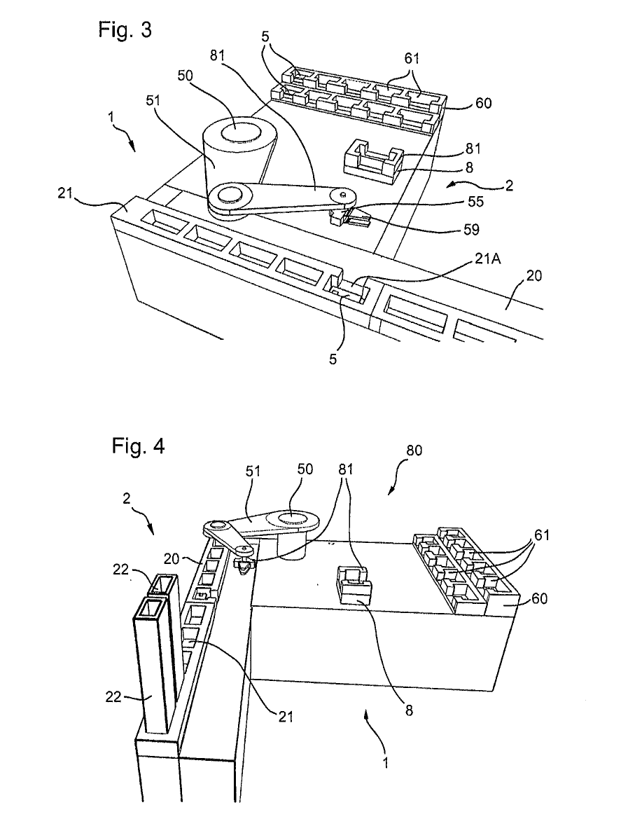

FIG. 3 a further sorting apparatus with a manipulator in a perspective schematic view;

FIG. 4 the apparatus according to FIG. 3, seen from a different direction;

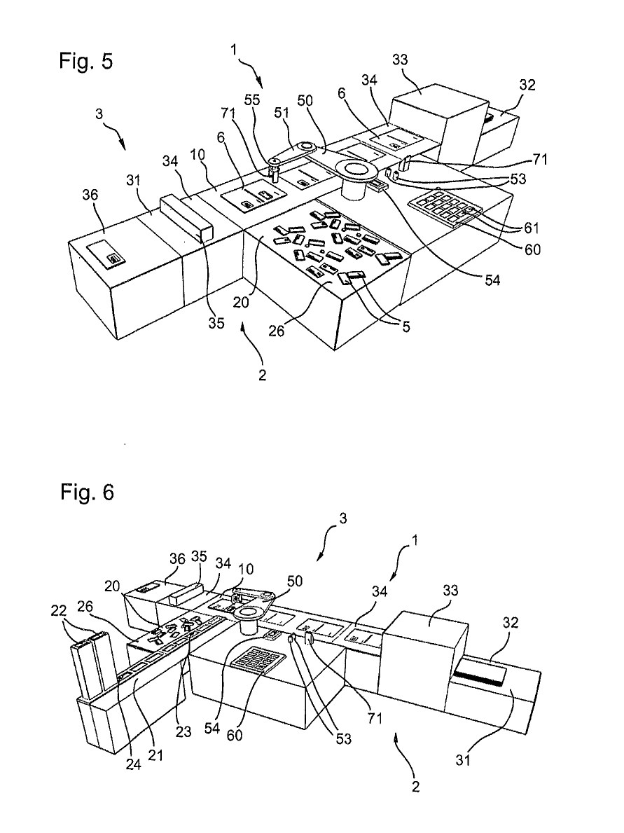

FIG. 5 an application apparatus with a manipulator in a perspective schematic view;

FIG. 6 a further application apparatus with a manipulator and a card channel in a perspective schematic view;

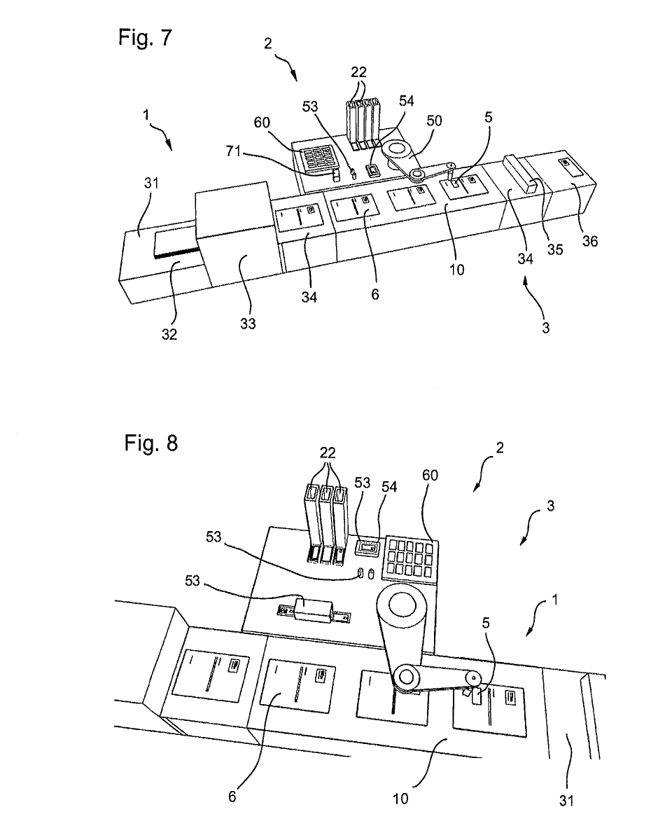

FIG. 7 a further application apparatus with a manipulator and card provisioning by means of magazines in a perspective schematic view;

FIG. 8 a further application apparatus with a manipulator and card provisioning by means of magazines as well as means for personalization of cards in a perspective schematic view;

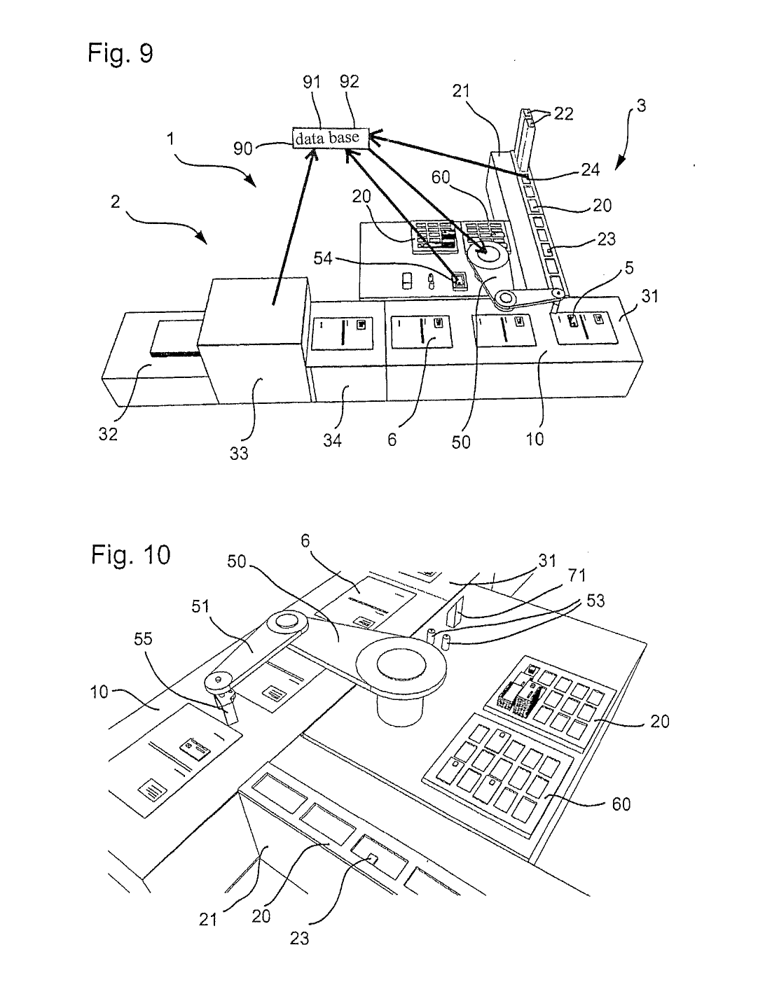

FIG. 9 a further application station with a manipulator and a card channel for card provisioning in a perspective schematic view, as well as a schematic representation of a database;

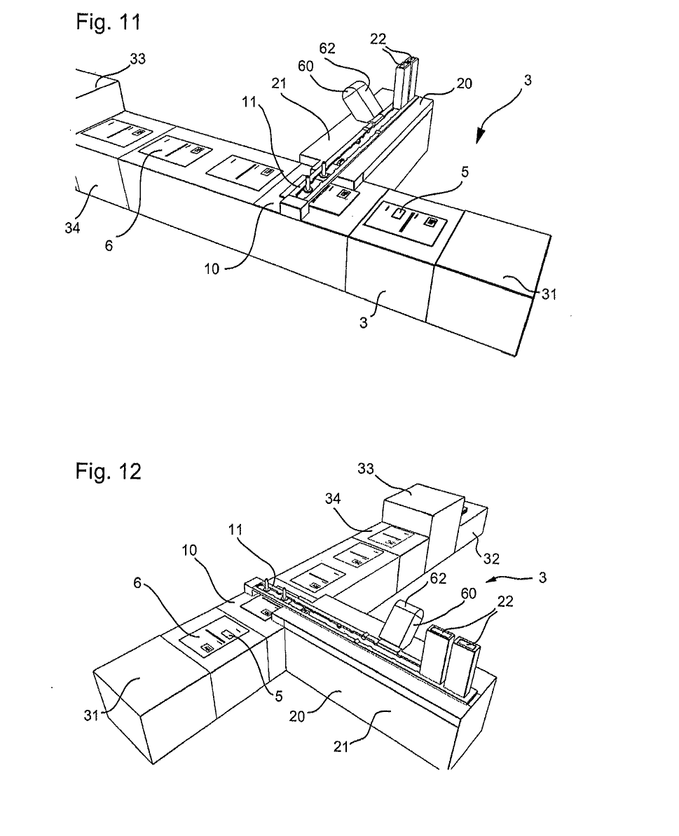

FIG. 10 the arrangement according to FIG. 9 in a detail view from a different perspective;

FIG. 11 a further application station with a card channel as a card provisioning unit as well as a conventional applicator and an independently addressable magazine as a temporary storage unit;

FIG. 12 the arrangement according to FIG. 11 from a different perspective;

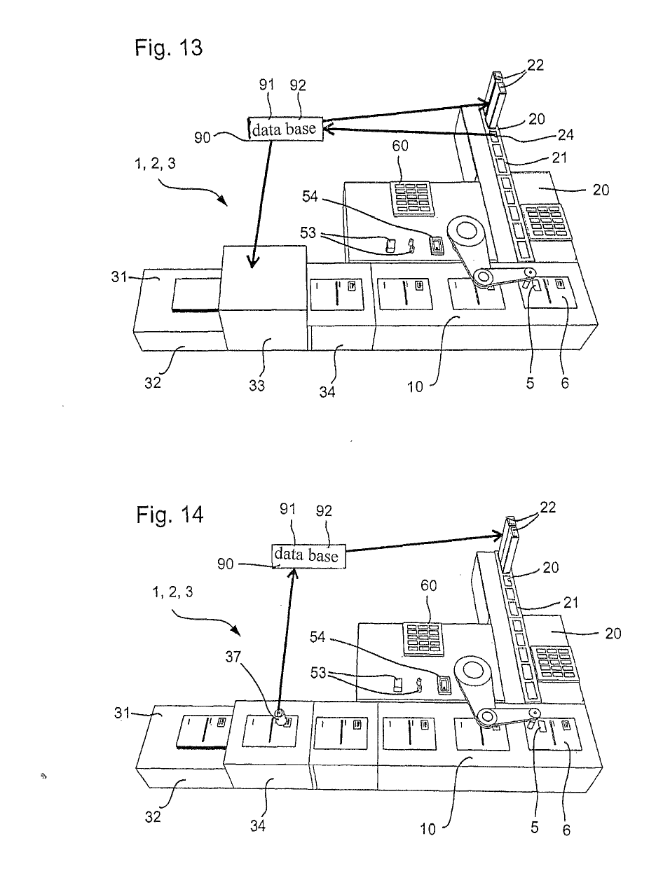

FIG. 13 a further application apparatus with a manipulator in a perspective schematic view and an exemplary representation of a database;

FIG. 14 a further application apparatus with a manipulator in a perspective schematic view and an exemplary representation of a database;

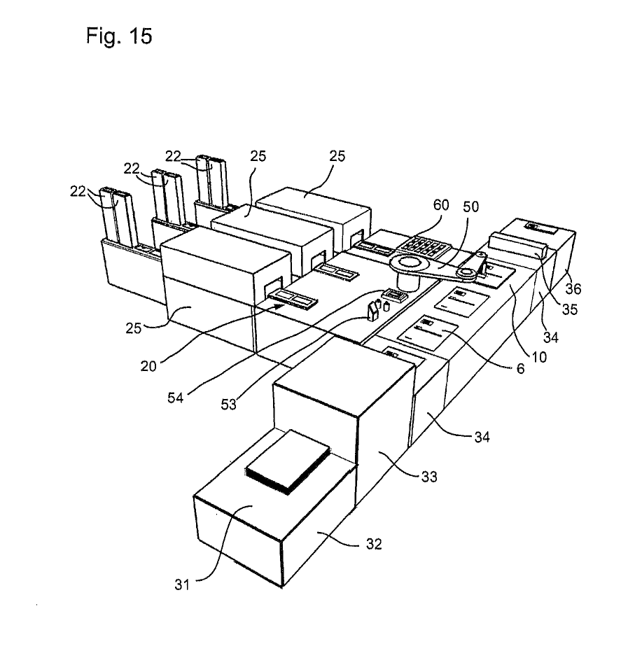

FIG. 15 a further application apparatus with a manipulator as well as multiple personalization stations in a perspective schematic view;

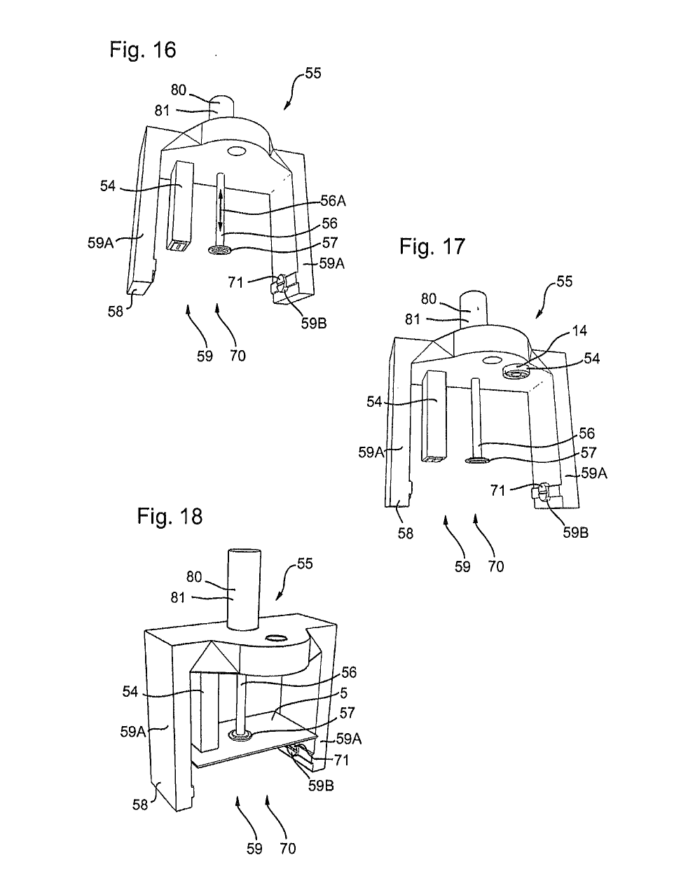

FIG. 16 a perspective representation of a first effector for a manipulator;

FIG. 17 a perspective representation of a second effector for a manipulator;

FIG. 18 the effector according to FIG. 17 with a card being grasped, in a different perspective;

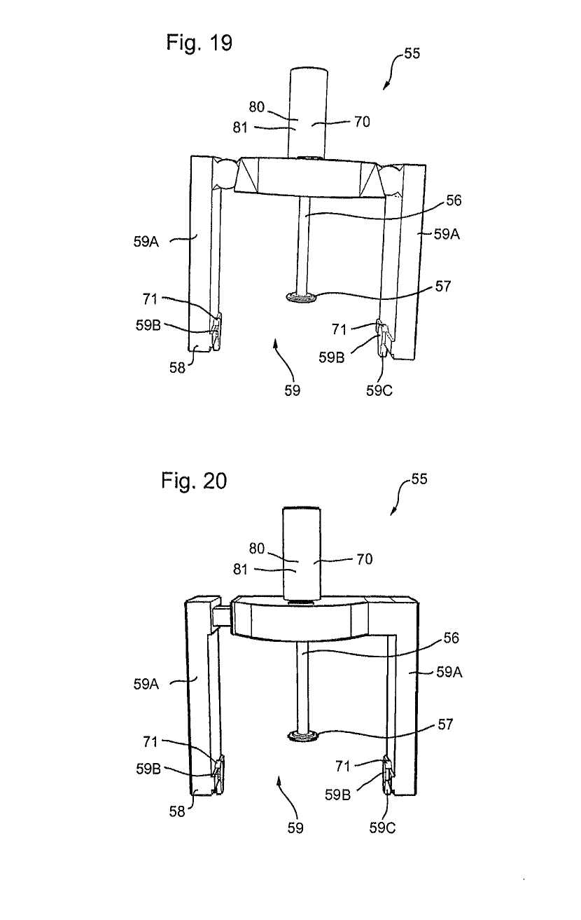

FIG. 19 a perspective representation of a further effector;

FIG. 20 a perspective representation of a further effector;

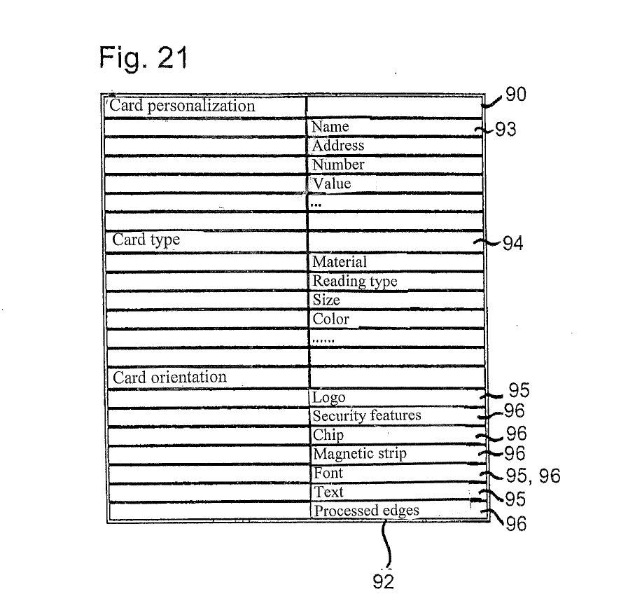

FIG. 21 schematically, allocation of a database;

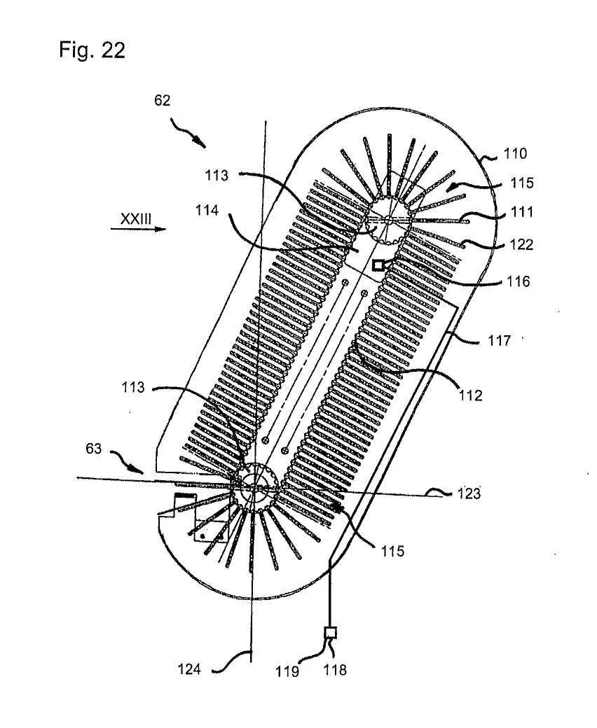

FIG. 22 a section through a card magazine;

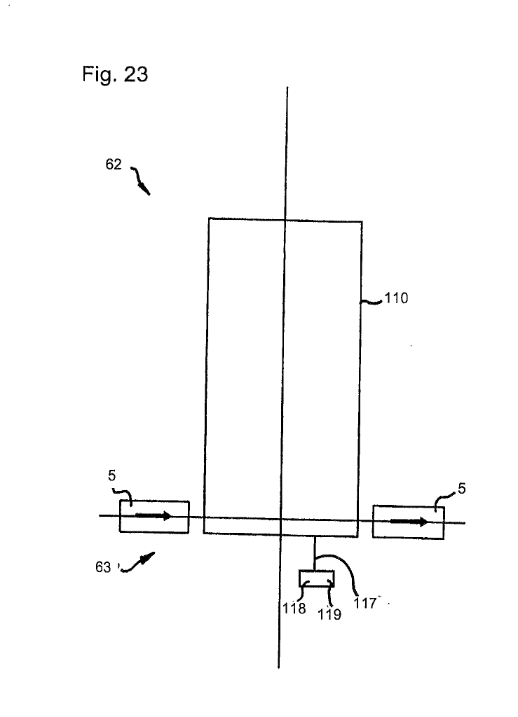

FIG. 23 a schematic front view in the direction of the arrow XXII of the card magazine according to FIG. 22;

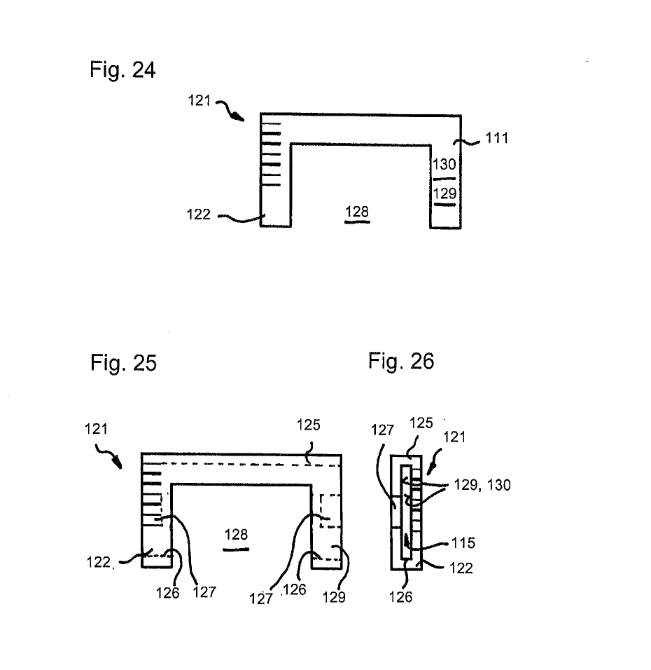

FIG. 24 a top view of a card holder of the card magazine according to FIGS. 22 and 23;

FIG. 25 a top view of an alternative card holder;

FIG. 26 a side view of the card holder according to FIG. 25; and

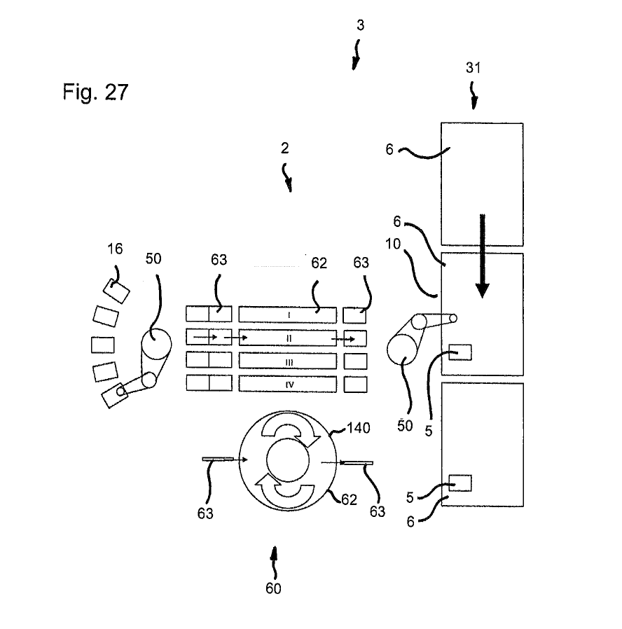

FIG. 27 a top view of further application apparatus.

The handling apparatus 1 or sorting apparatus 2 shown in FIG. 1 comprises a table 26 as a card provisioning unit 20, onto which different cards 5 can be placed in different arrangements. In this connection, these can be, on the one hand, cards 5A with personalized data, cards 5B with magnetic strips, cards 5C with a chip, cards 5D merely imprinted with a picture, or also SIM cards 5E. It is understood that in this regard, other cards can also be processed accordingly.

The handling apparatus 1 or sorting apparatus 2 furthermore has a manipulator 50 with an arm 51, which carries an effector 55 as a horizontal articulated arm robot, with which the cards 5 are grasped and can be set down onto different temporary storage locations 61 of two temporary storage units 60, on the one hand or at output locations 16 of magazines (17) of a card output unit. Also, a card processing station 53 or measurement station 54 in the form of a chip card reading and writing device 7 is disposed in the area of the manipulator 50.

Not shown in FIG. 1 is a camera, which, depending on the concrete embodiment, is set up fixed in place on the table 26 or disposed on the effector 55, so that the cards 5 can be visually recorded and grasped by the manipulator 50 in the desired manner. In this connection, it is also possible to read out possible chip cards by way of the card processing station 53 or measurement station 54, or also to write to them in targeted manner for personalization.

Therefore it is easily possible to pick up cards 5 from the table 26 and to sort them by way of the temporary storage unit 60, in that the card are deposited there, either individually or sorted in stacks. In this connection, the cards can then be given, sorted, to output locations 16, from which they are filled into the magazines 17. The cards can then be removed for further processing purposes in the magazines 17. For example, the cards, which were sorted accordingly, can be supplied to an application apparatus.

The effector 55 can rotate about a vertical axis, so that it serves as a rotator and can orient the cards horizontally, in suitable manner. In the following, extra labeling of the rotator is generally eliminated, because this characteristic appears obvious. It cannot be directly derived from FIG. 1 that the effector 55 is also structured as a turner, so that cards can be turned, if desired, if they are lying on the table 26 with the wrong side up.

In the following figures, the different card types or kinds of cards are no longer labeled individually, for the sake of clarity. Ultimately, the card type or kind of card plays a subordinate role anyway, because if possible, the most varied types of cards 5 are supposed to be handled or sorted accordingly.

As can be directly understood, the manipulator can move to or call on the individual temporary storage locations 61 and thereby address them independently. Because the cards 5 are deposited in the temporary storage unit 60 and can also be removed from there again by the manipulator 50, this is a reversible temporary storage unit 60.

It is understood that cards 5 can also be removed from the temporary storage unit 60 manually when the apparatus is at a standstill, if they—for any reason whatsoever, for example if they were defective—cannot or should not be processed further in the process just concluded. For safety reasons, this should not take place when the manipulator 50 might be moving to the temporary storage locations 61, whereby—if such a removal possibility proves to be practical during the ongoing process a card removal transport, not shown here, such as, for example, a separate card conveyor or a slide, can be used, by means of which the cards to be sorted out can be removed from the work area of the manipulator 50. In the case of a slide or the like, this takes place directly, of course, when the manipulator 50 sets a card 5 down onto the slide, accordingly, unless a separate tilting or holding apparatus is provided, which holds a card 5 in a temporary storage location 61 here or actually allows multiple cards to accumulate until a decision to sort the card 5 out was made. Also, a conveyor belt or a transport carriage can be provided, by means of which cards 5 or groups of cards 5 can be sorted out as needed.

The handling apparatus 1 or sorting apparatus 2 according to FIG. 2 essentially corresponds to the arrangement according to FIG. 1, so that multiple explanations of identical modules or modules with the identical effect will not be provided. The method of procedure is the same with regard to the following exemplary embodiments, as well.

In deviation from the exemplary embodiment according to FIG. 1, the arrangement according to FIG. 2 comprises two magazines 62 that are configured, purely mechanically, in accordance with the magazines according to WO 2004/039711 A1, as rotating temporary storage units 60. However, these magazines 62 were modified, supplemental to the embodiment according to the state of the art, to the effect that the individual temporary storage locations of these magazines can be individually and independently addressed, so that cards can be removed from specific temporary storage locations in targeted manner and can also be deposited there. In this manner, sorting can take place, particularly by way of the magazines 62, in that the manipulator 50 deposits cards 5 at the inputs and/or outputs 63 of these magazines 62. For further sorting purposes, the arrangement according to FIG. 2 also has a temporary storage unit 60 with temporary storage locations 61 disposed next to one another and in front of or behind one another, as is also provided in the case of the exemplary embodiment according to FIG. 1. In this way, sorting activities can be performed in significantly simpler manner than with the magazines 62. However, one of the plates provided with storage locations 61 in two dimensions is not used as a temporary storage unit as in the exemplary embodiment according to FIG. 1, but rather as a card output unit 15 with multiple output locations 16, from which correspondingly sorted card stacks can then be removed by hand, as needed.

It is understood that the arrangements shown in FIGS. 1 and 2 can also be combined with one another and expanded with further temporary storage units 60 or card processing stations 53 and measurement stations 54, whereby it is already directly evident from the drawing that for this purpose, sufficient room remains in the area of the manipulator 50, so that as a result, a particularly compact embodiment is easily possible, even in the case of a multiplicity of assemblies.

The apparatuses shown in FIGS. 3 and 4 are also a handling apparatus 1 or sorting apparatus 2, in which, however, the cards 5 are supplied in a conventional card provisioning unit 20, by means of a known card channel 21, from magazines 22. In deviation from the state of the art, the card channel 21 has a removal opening 21A, through which a card 5 can be removed from the card channel 21 by means of a gripper 59 that is provided on the effector 55 of the manipulator 50.

This arrangement, too, has a temporary storage unit 60 with temporary storage locations 61 disposed in two dimensions relative to one another, which also have removal openings 21A, in each instance, in this exemplary embodiment, so that the gripper 59 can set cards 5 down there and remove them again.

As is directly evident, in this exemplary embodiment the cards 5 can easily be turned in that the effector 55 or the gripper 59 is rotated about a horizontal axis. Rotation is more difficult in this embodiment, and an additional compartment 8 that has two removal openings, not numbered, serves for this purpose, so that the gripper can place a card in from one side and take it out again from the other side. In this manner, rotation of the cards by 180° in the card plane is also easily possible with this arrangement, so that the rotator 80 in this exemplary embodiment is formed by two rotator modules 81, namely the additional compartment 8 and the manipulator 50 or its effector 55.

By means of this arrangement, cards 5 can easily be removed from the card channel 20, sorted, and put down again, so that possible errors that are found in a sorting sequence of the magazines 22 can be corrected. In this connection, the card channel 21 can, depending on the concrete implementation of the present embodiment, open into a magazine again or lead to an application area or to similar devices. Alternatively, another card output, not shown here, can also be provided.

The application apparatus 3 shown in FIG. 5, which accordingly comprises a handling apparatus 1 and a sorting apparatus 2, in turn has a table 26 as a card provisioning unit 20 for cards 5, as was already explained for the exemplary embodiments according to FIGS. 1 and 2. Furthermore, the application apparatus 3 comprises a manipulator 50, within the reach of which, on the one hand, an application area 10 for uniting the cards 5 with card supports 6 and, on the other hand, a temporary storage unit 60 with multiple temporary storage locations 61 disposed in two dimensions relative to one another and multiple processing stations 53 or measurement stations 54 are disposed.

Furthermore, this application apparatus 3 comprises a card support channel 31 with a supply 32 and a measurement station 34, which channel leads to the application area 10, and, proceeding from this, another measurement station 34 for a final inspection, a folding station 35, and an output 36. In concrete terms, in this exemplary embodiment the card supports 6 are sheets of paper, which are to be united with the cards 5, whereby accordingly, the processing station 33 is a printer, and the supply 32 is a corresponding printer tray.

The printed sheets of paper are inspected in the measurement station 34, by way of a camera, not shown, and sorted out, if necessary, which makes temporary storage necessary, precisely as needed.

After the inspection, the card supports 6 or the letters are united with the cards 5, whereupon another measurement station 34 follows, which also checks, by means of a camera, whether the correct card 5 was applied to the correct card support 6. Afterward, folding to produce finished letters takes place in the folding station 35; these letters are then made available at the output 36 for further treatments.

In the exemplary embodiment shown in FIG. 5, a chip card and magnetic strip reader is disposed within reach of the manipulator 50, as the measurement station 54, as are two glue dot dispensers as processing stations 53, so that personalized data in the cards 5, in each instance, can be read out, before the corresponding cards 5 are temporarily stored in the temporary storage unit 60. A corresponding print order is then issued to the printer 33 with the readout, whereby the measurement station 34 once again reports, if a corresponding card support 6 was produced accurately and correctly, that the manipulator 50 removes the correct card 5 from the temporary storage unit 60 and applies it to the related card support 6 in the application area 10. In this manner, a corresponding letter can be produced in extremely individual manner, using the data found on the card. Corruption of the adhesive, of the cards 5 or of other components of the apparatus can be effectively avoided by means of the glue dot dispensers that are used only immediately before application of a card 5.

In the exemplary embodiment, the effector 55 is directly suitable as a rotator, in that it is rotated about its vertical axis, so that here, no separate labeling is provided. Furthermore, however, the effector 55 comprises a passive turner module 71, which can be fixed in place or released, merely rotating about a horizontal axis. By way of a prism as a further turner module 71, within reach of the manipulator, a card can now be turned, if necessary, if it is lying with its top down on the table 26 and is supposed to be applied to the card support 6 the other way around. Such an embodiment has the advantage that it is possible to do without a complex motorized system on the effector 55 for turning.

The application apparatus 3 shown in FIG. 6, which also comprises a handling apparatus 1 or sorting apparatus 2, essentially corresponds to the arrangement according to FIG. 5, and is merely supplemented with a card channel 21 that supplies cards from magazines 22, as a component of the card provisioning unit 20, to the application area 10.

In this connection, the cards 5 supplied by way of the card channel 21 correspond to a standard large-series order, whereby personalized data of a card 5 are read by way of a chip and magnetic strip reading apparatus as a measurement station 24, and a corresponding print order is issued to the printer 33. If a correspondingly prepared card support 6 or letter moves past the inspecting measurement station 34 after the printer 33 and is not sorted out, the corresponding card is provided with a glue dot at a processing station 23, and removed from the card channel 21 by means of the manipulator 50, and applied to the corresponding card support 6. If a card support 6 that has already been ordered is sorted out at the measurement station 34, then application by the manipulator 50 does not take place, but rather the card 5, in each instance, is placed into the temporary storage unit 60 without a glue dot. A renewed print order is issued to the printer 33, so that the card is removed from the temporary storage unit 60, provided with a glue dot at the processing station 53, and applied to the corresponding card support 6 if the newly printed card support 6 moves past the measurement station 34 and is not sorted out.

As was already explained using the exemplary embodiment according to FIG. 5, the manipulator 50 also picks up cards 5 that are lying on the table 26 of the card provisioning unit 20, lays them down in the chip and magnetic strip reading device of the processing station 54, in order to detect their data and also to temporarily store them in the temporary storage unit 60 until a corresponding card support 6 is available for application in the application area 10, after issuance of a corresponding print order.

The arrangement shown in FIG. 7 also essentially corresponds to the arrangements shown in FIGS. 5 and 6, whereby, however, in contrast to the arrangement according to FIG. 6, no card channel 21 and no table 26 of the card provisioning unit 20 was provided. Here, the card provisioning unit merely comprises four magazines 22. For the remainder, the arrangement according to FIG. 7 corresponds to the arrangements according to FIGS. 5 and 6, and is also similar to them in terms of its method of functioning.

The manipulator 50 removes cards 5, in each instance, from the magazines 22, whereby the kind of card or card type per magazine 22 is known. In this regard, the manipulator 50 merely sets the cards 5 onto the measurement station configured as a chip and magnetic card reader, in order to then start a correspondingly personalized printing order, whereby a card, in each instance, is then temporary stored for a correspondingly long period of time. In this exemplary embodiment, non-personalized cards can be supplied directly to the application area 10 and applied to a corresponding card support 6 there. Before application, all the cards 5 are first passed to the processing station 53, for application of a glue dot.

The exemplary embodiment shown in FIG. 8 essentially corresponds to the exemplary embodiment according to FIG. 7, whereby, however, only three magazines 22 are used, and a chip and magnetic strip card reading and writing device is provided as the card processing station 53 and measurement station 54. Supplemental to this, a further card processing station 53 is provided within reach of the manipulator 50, which station is able to also individualize or personalize cards visually, whereby in this exemplary embodiment, at this location a film printer for imprinting photos, particularly passport photos, is provided. Because personalization takes a relatively long time, in this connection, card blanks are first imprinted accordingly and also individualized accordingly, with regard to their magnetic strip or chip, and placed in the temporary storage unit 60. Only then is a corresponding print order for the card supports 6 issued. If no corresponding individualization is provided, the cards 5 can be directly applied to a card support 6, in each instance, circumventing the temporary storage unit 60, whereby temporary storage of those cards 5 takes place, if applicable, if a card support 6 that has actually already been announced is sorted out on a short-term basis, due to some kind of error.

The embodiment shown in FIGS. 9 and 10 also essentially corresponds to the embodiment according to FIG. 6, whereby a table 26 for supplying cards was eliminated. The card provisioning unit 20 furthermore comprises, however, a plate not numbered in detail, which essentially corresponds to the plate of the temporary storage unit 60, so that here, individual cards can easily be set down, which cards the manipulator 50 can then pick up as needed. In this connection, these cards can be read in and recognized by way of the processing station 53, if necessary, so that a database can undertake a corresponding assignment.

In an alternative implementation, it can be necessary to manually report the cards 5 laid down manually by way of the plate of the card provisioning unit 20, for example by way of a suitable computer terminal, to the database or the corresponding process controller.

Furthermore, this arrangement works slightly differently from the arrangements listed above, because it is assumed that the corresponding total order was previously preconfigured to a sufficient degree. This means that not only the printer 33 but also the card channel 21 works with the magazine 22 according to firmly predetermined and prepared orders. A corresponding inspection takes place by way of the measurement stations 24 and 34, and this is reported to the database 90, which then activates the manipulator 50 accordingly. A separate order is issued for cards 5 sorted out by the manipulator 50, similarly as for the cards 5 set down manually by way of the plate of the card provisioning unit 20, which order is then started by way of the printer 33, and the database 90 and, by way of the latter, the manipulator 50 are activated in suitable manner. It is understood that in this regard, different method management, particularly also the method management as explained for the preceding or following exemplary embodiments, can be carried out.

The application apparatus 3 shown in FIGS. 11 and 12 makes use, as such, of a conventional application apparatus, whereby, however, a buffer known from the state of the art has been modified as a temporary storage unit 60 in the form of a magazine 62, in that this unit has been provided with independently addressable storage locations. In this manner, a card situated in the temporary storage unit 60 can be removed from the temporary storage unit 60 again, as needed, and individually supplied, by way of the card channel 21, to the application area 10, in which a conventional applicator 11 for the cards is provided. In this regard, the related cards 5 for the card support 6, in each instance, can be requested, in targeted manner, from the storage unit 60, for example by means of the measurement station 34, which reads out personalized data of the corresponding card support 6. Likewise, cards 5, for which no card support 6 is available in timely manner, for whatever reason, but which have already been dispensed from the magazine 22, can be temporarily stored in the temporary storage unit 60.

The arrangements shown in FIGS. 13 and 14 essentially correspond to the arrangement according to FIG. 6, whereby, however, a separate plate that corresponds to the temporary storage unit 60 is used instead of the table 26, as an additional card provisioning unit 20, so that here, an arrangement similar to the arrangement shown in FIG. 9 is present, and merely the plate of the card provisioning unit 20 is disposed at a different location.

In the exemplary embodiment shown in FIG. 13, the database 90 controls the magazines 22 directly, and thereby sets the basic rhythm of the application apparatus 3 according to FIG. 13. The card 5 ultimately output by the magazine 22 is reported to the database by way of the measurement station 24, which was already explained in detail above, and the database then issues a corresponding print order to the printer 33, so that the corresponding card 5 and the related card support 6 can be united accordingly.

In the event of possible malfunctions, the cards are placed in the temporary storage unit 60, as already explained in detail above, and a renewed print order is issued.

Individual cards can be supplied to the method by way of the plate of the card provisioning unit 20, whereby these are then read into the measurement station 54, accordingly, and reported to the database 90, so that the latter can issue a corresponding print order.

Because the card channel 21, in this exemplary embodiment, does not have its own glue dot application unit, each card is provided with a glue dot before application, in this exemplary embodiment, in the card processing stations 53.

In deviation from the exemplary embodiments presented above, the manipulator 50, with its effector 55, is configured not only as a turner but also as a rotator, so that it is possible to do without a separate turner module 71. Instead, a further card processing station 53 is provided, by means of which double-sided adhesive labels can be applied to the cards 5, which is preferable to a glue dot composed of liquid adhesive in the case of certain card materials.

In the exemplary embodiment shown in FIG. 14, no printer 33 is provided in the card support channel 31. In this exemplary embodiment, the card supports 6 are made available separately. A card support 6 is checked by way of a camera 37 at the measurement station 34, and a corresponding order for output of a card from the magazine 22 is issued, which cards are then supplied to the application area 10 by way of the card channel 21. Special cards can be made available by way of the separate plate of the card provisioning unit 20, which cards, if necessary—similar to the situation of possible incorrect deliveries from the magazine 22, can also be temporarily stored in the temporary storage unit 60, until a matching card support 6 is available.

Where the plate for additional card provisioning is provided in the exemplary embodiments according to FIGS. 13 and 14, the arrangement according to FIG. 15 has the temporary storage unit 60, whereby in comparison with the exemplary embodiments shown in FIGS. 14 and 13, three personalization stations 25 are provided instead of the temporary storage unit 60, in which stations cards 5 kept on hand in magazines 22 can be personalized in extremely individual manner. Such personalization particularly relates to punching or embossing, and to imprinting of the card 5, in each instance, either with logos of the companies issuing the cards, in each instance, or also with pictures of the users, in each instance, which can be implemented by means of suitable printers, such as inkjet printers and film printers, in practice.

The effectors 55 shown in FIGS. 16 to 20 can be used, in each instance, in the manipulators 50 of the exemplary embodiment explained above, depending on the concrete implementation.

Thus, all these effectors 55 have a first card carrying tool 56 that comprises a suction device 57, which in turn can be vertically displaced, as indicated by the double arrow 56A, indicated as an example in FIG. 16, but also implemented in other embodiments according to FIGS. 17 to 20. A card 5, as shown as an example in FIG. 18, can easily be grasped and carried on one of its sides, by way of the suction device 57. This particularly allows picking it up from possible stacks or possible surfaces on which the cards 5 are lying, as well as applying it to card supports 6.

Furthermore, the effectors shown in FIGS. 16 to 20 have a second card carrying tool 58, which comprises a gripper 59, by means of which the cards 5 can be grasped at opposite edges, in each instance, which makes this gripper 59 differ from the gripper of the exemplary embodiment according to FIGS. 3 and 4, which grasps the cards at their top and bottom, in each instance.

In the exemplary embodiments shown in FIGS. 16 to 18, the gripper 59 has rigid arms 59A, in each instance, which carry an active gripper element 59D, in each instance, which can be displaced parallel to the plane of the cards 5. In these exemplary embodiments, the gripper element 59B is actively controlled and can be moved toward the card and away from the card, in the card plane, by means of a motor or by means of a corresponding actuator. When the suction device 57 is situated in a vertical position, in which the gripper elements 59B can grasp the card with their slot, then the gripper elements 59B are moved toward the card 5 by means of the actuator, and the card 5 is grasped with shape fit, in this manner. Then the first card carrying tool 59 can release the card 5.

In an alternative embodiment, the gripper elements 59B can be configured passively, so that the first card carrying tool 56 clamps the card between the gripper elements 59B, which are biased, for example by means of a spring, in the direction toward the cards. To take the card out, the first card carrying tool 56 can then be connected with the card 5 again, and can eject the latter from the gripper elements 59B by means of corresponding force.

In the exemplary embodiments shown in FIGS. 16 to 18, a chip card reader is furthermore provided as a measurement station 54, against which reader the card 5 can be pressed by means of the first card carrying tool 56, so that a chip card of the card 5 can be read out during transport with the effector 55.

Furthermore, the embodiment shown in FIGS. 17 and 18 also has a camera as a measurement station 54, by means of which image recognition and barcode recognition can be undertaken to read in personalized data, on the one hand. Likewise, the camera 14 can also be used for targeted application and its inspection, and for searching for cards on a table 26.

Furthermore, the gripper elements 59B are mounted in the arms 59A so as to rotate, whereby corresponding engagement elements ensure that these can only rotate when a card 5 is actually grasped by the gripper elements 59B. In this manner, it is ensured that the gripper elements 59B maintain their position when no card 5 is being grasped by them.

By means of the first card carrying tool 56, the position of the card can furthermore be secured when a card 5 is grasped. Corresponding securing is opened by means of retraction of the suction device 57, when the effectors 55 shown in FIGS. 16 to 18 are guided to a turner module 71 that is fixed in place, and thus the manipulator 50 turns the corresponding card 5 in targeted manner. Accordingly, the gripper elements 59B are also turner modules 71 of a turner 70.

In a manipulator, it can easily be implemented that the effector 55 is rotated about a vertical axis or about an axis perpendicular to the cards 5, so that the effectors 55 shown in FIGS. 16 to 18 can easily also serve as rotators 80 and accordingly represent a rotator module 81.

The same holds true for the effectors 55 shown in FIGS. 19 and 20.

However, the gripper elements 59B of the effectors 55 shown in FIGS. 19 and 20 are configured to rotate actively, in other words with their own motor drive, about a horizontal axis. For this reason, in these two exemplary embodiments, the gripper elements 59B are the only parts that make the turner module 71 available, so that the effector 55 of the exemplary embodiments shown in FIGS. 19 and 20 is also a turner 70.

Furthermore, in the exemplary embodiment according to FIG. 19, both arms 59A can be moved away from the cards or toward the card 5 by way of joints, so that active gripping can take place. The same holds true for the arrangement according to FIG. 20, whereby there, only one arm 59A is horizontally displaceable, which is implemented by way of a slide.

It is understood that in the arrangements according to FIGS. 19 and 20, measurement stations 54 or card processing stations 53 can also be provided, as is indicated, as an example, in the exemplary embodiments according to FIGS. 16 to 18.

Furthermore, extensions 59C are provided on the gripper elements 59B in the exemplary embodiments shown in FIGS. 19 and 20, which make it possible to grasp cards 5 in the manner of tweezers. For turning, however, cards are preferably disposed in the central rotational center of the gripper elements 59B, with the first card carrying tool 56.

In the database 90, as it is presented as an example, particularly in FIGS. 9, 13, and 14, card support data sets 91 and card data sets 92 are present, so that a corresponding data reconciliation can easily be carried out.

In this connection, the card data set 92 has not only personalization data 93 and card type data 94, which is actually known, but also visual data 95 or position data 96, as indicated in FIG. 21 as an example. Likewise, data concerning the kind of card can be stored in the card data set 92, in each instance. By means of a database 90 configured in this manner, it is possible to undertake targeted card orientation in automated manner.

The magazines 62 as such can be structured in different ways. A detailed example of a magazine 62 is represented in FIGS. 22 and 23, and comprises a housing 110, within which a plurality of card holders 111 are provided on a belt 112 that circulates around deflection rollers 113.

In this exemplary embodiment, the upper deflection roller 113 is driven by a drive 114, which in turn can be put into motion and stopped by means of an actuator 116, in desired manner.

The actuator 116 is connected, by way of a line 117, with a signal input 118 and signal output 119 which are implemented, in this exemplary embodiment, by way of a common plug, which also ensures a current or voltage supply.

Furthermore, the actuator 116 is connected, by way of a line, not shown, with an address reading device 120 that reads out addresses that are applied to the card holders 111, which thereby serve as address supports 122, as binary code 121 (see FIG. 24), and passes them on to the actuator 116.

In this connection, the latter is configured in such a manner that the drive 114, similar to a stepper motor, only stops when a card holder 111 is positioned precisely in position with reference to the input and/or output 63, in other words, in this exemplary embodiment, precisely horizontally (horizontal 123), so that card input or card output can take place.

While in the exemplary embodiment shown in FIGS. 22 and 23 the card input or card output takes place laterally, the card output or card input can also take place frontally, as is directly evident, as is indicated as an example in the exemplary embodiment according to FIG. 2.

Card spaces 115 are formed between the card holders 111, which spaces can be unambiguously addressed by means of the codes 121 of the card holder 111 or address supports 122. By means of a suitable selection of the geometric shape of the housing 110, the cards 5 can be prevented from falling out of these card spaces 115.

At greater rotational speeds, the latter can lead to malfunctions or to noises or to damage to the cards 5, which can be avoided by means of a card holder 125 that ultimately forms a card space 115 in itself, and not, as shown in the exemplary embodiment according to FIGS. 22 to 24, in interplay with adjacent card holders 111. The same can also be implemented by means of other measures, such as, for example, slide rails disposed to circulate, holding clamps that circulate, or the like.

In this connection, the card holder 125 also comprises outer contact locations 126, which delimit and define the card spaces 115, particularly radially to the outside. Cards 5 can be pushed into or out of the card spaces 115 at the input and/or output 63, by way of a lateral opening 127, in that corresponding drive devices engage into the openings 127.

It is understood that card holder 111 and address support 122 are not necessarily implemented on identical modules, but rather can also be implemented in different modules.

Both card holders 111 and 125 have a recess 128, in each instance, which is implemented, in these exemplary embodiments, by means of a complete elimination of material at this location, but can also be formed, if necessary, by a correspondingly thinner material layer of the card holder 111, 125 in a corresponding area. In this connection, the recess 128 has a holder edge 129 of the card holder 111, 125, in each instance, at least on two sides, in the present exemplary embodiments actually on three sides, which form a card contact surface 130, in each instance, so that an adhesive location on a card 5 cannot degenerate as quickly in the magazine, in each instance, in the area of the recess 128.

The application apparatus 3 shown in FIG. 27 comprises a sorting apparatus 2 and two manipulators 50, whereby a first manipulator 50 has an application area 10 for uniting cards 5 with card supports 6 within its reach, on the one hand, and a temporary storage unit 60 with multiple magazines 62 and outputs 63, in each instance, on the other hand, while a second manipulator 50 has the inputs 63 that belong to the magazines 62, on the one hand, and multiple output locations 16 of magazines that are not explicitly shown, on the other hand. In this way, sorting work can be performed between the magazines that are not shown, with the output locations 16 and the outputs 63, and the first manipulator 50, using the magazines 62, so that these modules are an integral part of the sorting apparatus 2. It is understood that processing stations 53 or measurement stations 54 and the like can also be disposed within reach of the manipulators 50, if necessary, so that here, too, a handling apparatus can be present, in each instance.

Furthermore, this application apparatus 3 comprises a card support channel 31 that leads to the application area 10. In concrete terms, in this exemplary embodiment the card supports 6 are sheets of paper that are to be united with the cards 5, whereby depending on the concrete implementation of this exemplary embodiment, further stations, as they were already explained above, can also be present.

After sorting, the card supports 6 or the letters are united with the cards 5. In this connection, for example, completely unsorted cards 5 can be made available in the magazines at the output locations 16, which cards are then sorted into the magazines 62 by way of the second manipulator 50 and temporarily stored there. Depending on the demands of the system, the cards 5 stored in the magazines 62 can be made available to the first manipulator 50 at the outputs 63, in any desired sequence, so that the latter can then undertake the application in the desired sequence.

In this connection, it is possible that an entire day's throughput of cards 5 is temporarily stored in the magazines 62.

In this exemplary embodiment, the magazines 62, in each instance, are provided with cardholders disposed in circular manner in a circular card storage unit 140, which rotates, as is indicated in the lower part of FIG. 27. In this connection, it is assumed that a card storage unit 140 configured in this manner permits very high rotation speeds and a great number of card spaces as compared with the card storage unit shown in FIGS. 22 and 23. Also, such an embodiment allows doing without moving belts for conveying the card holders.

Depending on the concrete implementation, the card holders 111 or 125 can also be used, in particular, in the card storage unit 140.

### REFERENCE SYMBOL LIST

1 handling apparatus
2 sorting apparatus
3 application apparatus
5 card
5A card with personalized data
5B card with magnetic strip
5C card, imprinted only
5E SIM card
6 card support
7 chip card reading and writing device
8 additional compartment
10 application area
11 applicator
14 camera
15 card output unit
16 output location
17 magazine
20 card provisioning unit
21 card channel
21A removal opening
22 magazine
23 card processing station
24 measurement station
25 personalization station
26 table
31 card support channel
32 supply
33 processing station
34 measurement station
35 folding station
36 output
37 camera
50 manipulator
51 arm
53 card processing station
54 measurement station
55 effector
56 first card carrying tool
56A displacement direction
57 suction device
58 second card carrying tool
59 gripper
59A gripper
59B gripper element
59C extension
60 temporary storage unit
61 temporary storage location
62 magazine
63 input and/or output
70 turner
71 turner module
80 rotator
81 rotator module
90 database
91 card support data set
92 card data set
93 personalization data
94 card type
95 visual data
96 position data
110 housing
111 card holder
112 belt
113 deflection roller
114 drive
115 card space
116 actuator
117 line
118 signal input
119 signal output
120 address reading device
121 code
122 address support
123 horizontal
124 vertical
125 card holder
126 contact location
127 lateral opening
128 recess
129 holder edge
130 card contact surface
140 circular card storage unit

1-28. (canceled)

29. Apparatus for combining cards (5) and card supports (6) in an application area (10), in which cards (5) and card supports (6) are united with one another by way of an industrial manipulator (50), with a card provisioning unit (20) for supplying cards (5) to the application area (10) and with a card support channel (31) for supplying card supports (6) to the application area (10), wherein at least a card processing station (53), a measurement station (54) and/or a reversible temporary storage unit (60) are disposed within reach of the manipulator (50).

30. Apparatus according to claim 29, wherein at least two temporary storage locations (61) are disposed within reach of the manipulator (50).

31. Apparatus according to claim 29, wherein at least three temporary storage locations (61) are provided, which are disposed in two dimensions relative to one another.

32. Apparatus for combining cards (5) and card supports (6) in an application area (10), in which cards (5) and card supports (6) are united with one another, with a card provisioning unit (20) for supplying cards (5) to the application area (10), with a card support channel (31) for supplying card supports (6) to the application area (10), and with a temporary storage unit (60) for temporarily storing at least two cards (5), wherein the temporary storage unit (60) has independently addressable temporary storage locations (61).

33. Apparatus according to claim 32, wherein the temporary storage unit (60) comprises a magazine (62) having at least one input and/or output (63), which magazine is disposed in the area of a manipulator.

34. Method for combining cards (5) and card supports (6) in an application area (10), in which cards (5) and card supports (6) are united with one another by way of an industrial manipulator (50), wherein the manipulator (50) passes the card (5), after the card is picked up and before it is united with the card support (6), to a card processing station (53) and/or a measurement station (54) and/or a reversible temporary storage unit (60), as needed.

35. Method according to claim 34, wherein the manipulator (50) sets a card (5) down in the reversible temporary storage unit (60) and removes it from the reversible temporary storage unit (60) again, as needed.

36. Method for combining cards (5) and card supports (6) in an application area (10), in which cards (5) and card supports (6) are united with one another in targeted manner, wherein cards (5) that might not match or might have to be handled separately are temporarily stored in a temporary storage unit (60), wherein the cards (5) are removed from the temporary storage unit (60) in targeted manner, and united with a related card support (6).

37. Method according to claim 36, wherein before targeted removal of a card (5) from the temporary storage unit (60), a card support (6) corresponding to this card (5) is made available in the application area (10).

38. Method according to claim 36, wherein a card support data set (91) is assigned to each card support (6) and a card data set (92) is assigned to each card (5), and two card supports (6) and cards (5) to be united are identified and targeted removal from the temporary storage unit (60) takes place when the identified card support (6) is supplied to the application area (10).

39. Method according to claim 36, wherein an order for making a matching card support (6) available is issued before, while or after a related card (5) is placed into the temporary storage unit (60).

40. Method according to claim 39, wherein the card support (6) is created according to default values from a database (90), taking the card-specific data in the database (90) into account, in each instance.

41. Method according to claim 39, wherein a card support data set (91) is assigned to each card support (6) and a card data set (92) is assigned to each card (5), and two card supports (6) and cards (5) to be united are identified and targeted removal from the temporary storage unit (60) takes place when the identified card support (6) is supplied to the application area (10).

42. Method according to claim 36, wherein a card (5) is removed from the temporary storage unit (60) in targeted manner when a related card support (6) is supplied to the application area, wherein preferably, individual data of the card support (6) are measured for this purpose, and the temporary storage location (61) of the corresponding card (5) is determined on the basis of the measurement values from a database (90).

43. Method according to claim 42, wherein an order for making a matching card support (6) available is issued before, while or after a related card (5) is placed into the temporary storage unit (60).

44. Method according to claim 36, wherein the removal takes place by means of a manipulator (50).

45. Method according to claim 44, wherein the manipulator (50) sets cards (5) down at different temporary storage locations (61) and also picks them up again there, as needed.

46. Method according to claim 44, wherein the manipulator (50) is used for sorting out card supports (6), if necessary.

47. Method according to claim 44, wherein a card support data set (91) is assigned to each card support (6) and a card data set (92) is assigned to each card (5), and two card supports (6) and cards (5) to be united are identified and targeted removal from the temporary storage unit (60) takes place when the identified card support (6) is supplied to the application area (10).

48. Method according to claim 44, wherein an order for making a matching card support (6) available is issued before, while or after a related card (5) is placed into the temporary storage unit (60).
